(19) United States
(12) Patent Application Publication
(10) Pub. No.: US 2014/0217964 A1
(43) Pub. Date: Aug. 7, 2014

(54) POWER CONVERSION EQUIPMENT

(71) Applicant: Fuji Electric Co., Ltd., Kawasaki-shi (JP)

(72) Inventors: Hisashi FUJIMOTO, Tokyo (JP); Kouetsu FUJITA, Tokyo (JP); Kazuo KUROKI, Tokyo (JP)

(73) Assignee: FUJI ELECTRIC CO., LTD., Kawasaki-shi (JP)

(21) Appl. No.: 14/247,802

(22) Filed: Apr. 8, 2014

Related U.S. Application Data
(63) Continuation-in-part of application No. PCT/JP2012/006043, filed on Sep. 24, 2012.

(30) Foreign Application Priority Data
Oct. 31, 2011 (JP) 2011-238900

(51) Int. Cl. H02J 7/00

(52) U.S. Cl. CPC H02J 7/0052; H02J 2007/0059
USPC 320/107

(57) ABSTRACT

A power conversion equipment or apparatus includes an AC/DC conversion circuit which rectifies and converts an alternating current power source to a direct current, and a DC/AC conversion circuit which converts the direct current to a high frequency three-phase alternating current voltage having 3N pulses times a fundamental wave frequency in a half cycle, the fundamental wave frequency being higher than the frequency of the alternating current power source. The power conversion equipment also includes a three-phase high frequency transformer having a primary winding that is connected to the output of the DC/AC conversion circuit, a rectifier circuit which rectifies a secondary winding voltage of the three-phase high frequency transformer, and a filter circuit connected to the direct current output of the rectifier circuit.

### CROSS-REFERENCE TO RELATED APPLICATIONS

This is a continuation-in-part of International Application PCT/W2012/006043, with an international fling date of Sep. 24, 2012. Furthermore, this application claims the benefit of priority of Japanese application 2011-238900, filed Oct. 31, 2011. The disclosures of both of these earlier applications are incorporated herein by reference.

### BACKGROUND OF THE INVENTION

The present invention relates to a circuit configuration of a power conversion equipment or apparatus which generates a direct current from a three-phase alternating current power source and charges a storage battery.

FIG. 7 shows a circuit block diagram of a three-phase alternating current input storage battery charging circuit using a heretofore known technology, and FIGS. 8 to 10 show various AC/DC conversion circuit configuration examples.

As shown in FIG. 7, an alternating current power source 1 is connected to the primary winding of a transformer 3 via a breaker 2, the secondary winding of the transformer 3 is connected to the alternating current input of an AC/DC conversion circuit 4, and the direct current output of the AC/DC conversion circuit 4 is connected to a storage battery 5. FIGS. 8 to 10 show various circuit configuration examples of the AC/DC conversion circuit 4 in this kind of block configuration.

FIG. 8 is a circuit configuration described in PTL 1 (see below), which is configured of a filter circuit connected on the direct current output side of a diode rectifier circuit 6 and formed of a reactor 7 and capacitor 8. When the charging voltage of the storage battery reaches a prescribed value, the breaker 2 shown in FIG. 7 is opened.

FIG. 9 is a circuit configuration shown in PTL 2, which is of a configuration using a thyristor rectifier circuit 9, in place of the diode rectifier circuit of FIG. 8. As it is possible to control a direct current output voltage and current by a phase control of thyristors, it is possible to realize various charging modes such as an equalizing charge and a floating charge. The storage battery 5 is charged by a constant current control until a point at which the equalizing charge is completed, and the equalizing charge, after being completed, is switched to the floating charge, thus charging the storage battery 5 using a constant voltage control.

FIG. 10 is a circuit configuration shown in PTL 3, which is a configuration example using a high power factor rectifier circuit wherein reactors 10 are connected to the alternating current inputs of an IGBT bridge rectifier circuit 11 formed of six IGBTs to each of which a diode is connected in anti-parallel, and a capacitor 8 is connected to the direct current outputs of the IGBT bridge rectifier circuit 11, in place of the diode rectifier circuit 6 and thyristor rectifier circuit 9. It is possible, by a switching operation of the IGBTs, to control the voltage and current of the direct current outputs while making an alternating current input current higher in power factor.

### PATENT LITERATURE

PTL 1: JP-A-2-241331

PTL 2: JP-A-56-157228

PTL 3: JP-A-9-19160

### SUMMARY OF THE INVENTION

When using a commercial frequency insulating (or isolation) transformer in order to insulate the alternating current inputs and direct current outputs, as heretofore described, there is the problem that the device increases in size and mass. In order to solve the problem, there is also a method of using a single-phase high frequency transformer such as shown in a patent literature JP-A-10-70838, but the single-phase high frequency transformer has the problem that it is difficult to manufacture a large core, and it is difficult to realize a large-capacity charging device at a low price. Consequently, a problem for the invention to solve is to provide a large-capacity charging device, the inputs and outputs of which are insulated, in a small size and at a low price.

In order to solve the heretofore described problem, in a first aspect of the invention, a power conversion equipment or apparatus, which generates a direct current insulated from a three-phase alternating power source and charges a storage battery, includes an AC/DC conversion circuit which rectifies and converts an alternating current power source to a direct current; a DC/AC conversion circuit which converts the direct current to a high frequency three-phase alternating current voltage, including a number of pulses 3N (N is an integer of one or more) times a fundamental wave frequency in a half cycle of a phase voltage, whose fundamental wave frequency is higher than the frequency of the alternating current power source; a three-phase high frequency transformer whose primary winding is connected to the output of the DC/AC conversion circuit; a rectifier circuit which rectifies the secondary winding voltage of the three-phase high frequency transformer; and a filter circuit connected to the direct current output of the rectifier circuit, wherein the output of the filter circuit is connected to the storage battery.

In a second aspect of the invention, a reactor is connected in series to the three-phase high frequency transformer in the first aspect of the invention.

In a third aspect of the invention, a number of pulses 3N (N is an integer of one or more) times the fundamental wave frequency in the first or second aspect of the invention are formed from a direct current amount acting as a control signal and a carrier for modulating a pulse width.

In a fourth aspect of the invention, a diode is connected between the output of the filter circuit, and the storage battery, in the first to third aspects of the invention.

In the invention, a high frequency three-phase transformer with a frequency higher than the frequency of an alternating current power source is used as an insulating transformer for insulating an alternating current input and direct current output, and the transformer is driven by a three-phase output DC/AC conversion circuit (a high frequency inverter) including a number of pulses 3N (N is an integer of one or more) times a fundamental wave frequency in a half cycle of a phase voltage. As a result of this, it is possible to supply a large-capacity charging device in a small size and at a low price.

### BRIEF DESCRIPTION OF DRAWINGS

FIG. 1 is a circuit block diagram showing a first working example of the invention.

FIG. 2 is a detailed circuit diagram example of a DC/AC conversion circuit of FIG. 1.

FIG. 3 is an operating waveform example of the DC/AC conversion circuit of FIG. 2.

FIG. 4 is a circuit block diagram showing a second working example of the invention.

FIG. 5 is an illustration of details, and a commutation operation, of a rectifier circuit of FIG. 4.

FIG. 6 is a circuit block diagram showing a third working example of the invention.

FIG. 7 is a block diagram of a heretofore known charging circuit.

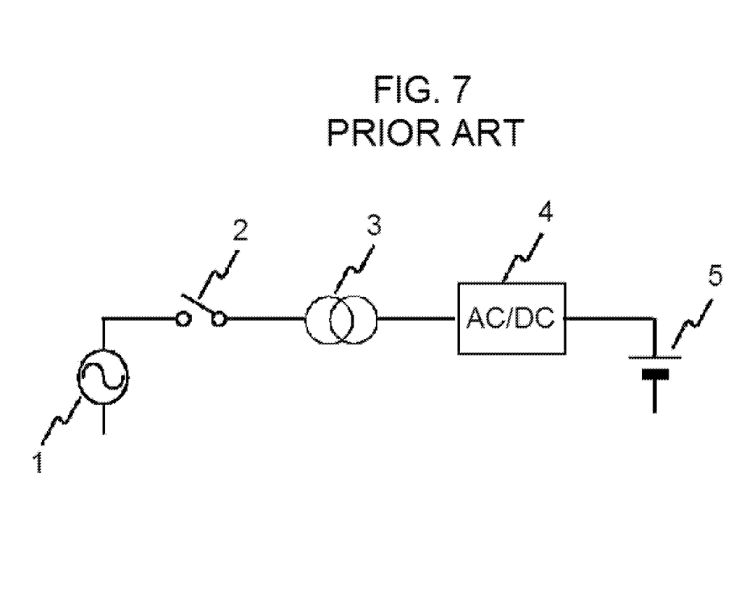

FIG. 8 is a detailed circuit diagram example 1 of an AC/DC conversion circuit of FIG. 7.

FIG. 9 is a detailed circuit diagram example 2 of the AC/DC conversion circuit of FIG. 7.

FIG. 10 is a detailed circuit diagram example 3 of the AC/DC conversion circuit of FIG. 7.

### DETAILED DESCRIPTION

The subject matter of the invention is that a power conversion device, which generates a direct current insulated from a three-phase alternating current power source and charges a storage battery, includes an AC/DC conversion circuit which rectifies and converts an alternating current power source to a direct current; a DC/AC conversion circuit which converts the direct current to a high frequency three-phase alternating current voltage, including a number of pulses 3N (N is an integer of one or more) times a fundamental wave frequency in a half cycle of a phase voltage, whose fundamental wave frequency is higher than the frequency of the alternating current power source; a three-phase high frequency transformer connected to the output of the DC/AC conversion circuit; a rectifier circuit which rectifies the secondary winding voltage of the three-phase high frequency transformer; and a filter circuit connected to the direct current output of the rectifier circuit, wherein the output of the filter circuit is connected to the storage battery.

### Working Example 1

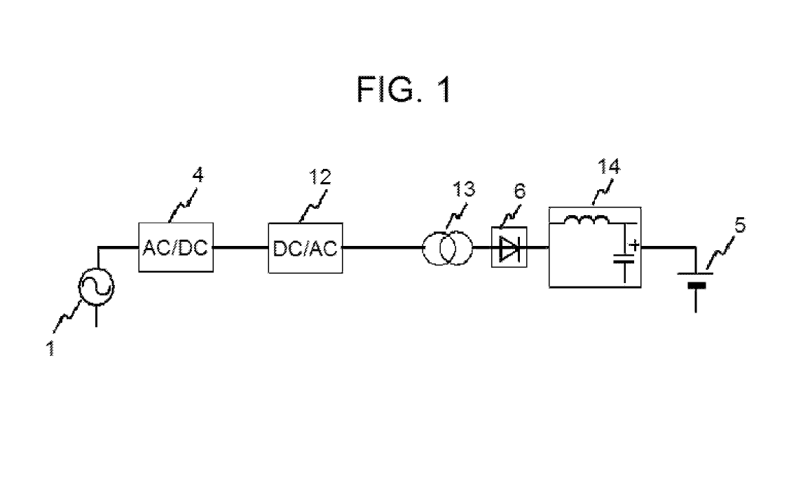

FIG. 1 shows a first working example of the invention. The configuration is such that an alternating current power source 1 is connected to the alternating current input of an AC/DC conversion circuit 4, the output of the AC/DC conversion circuit 4 is connected to the direct current input of a DC/AC conversion circuit 12, the output of the DC/AC conversion circuit 12 is connected to the primary winding of a three-phase high frequency transformer 13, the secondary winding of the three-phase high frequency transformer 13 is connected to the alternating current input of a rectifier current 6, the direct current output of the rectifier circuit 6 is connected to the input of a filter circuit 4, and the output of the filter circuit 14 is connected to a storage battery 5.

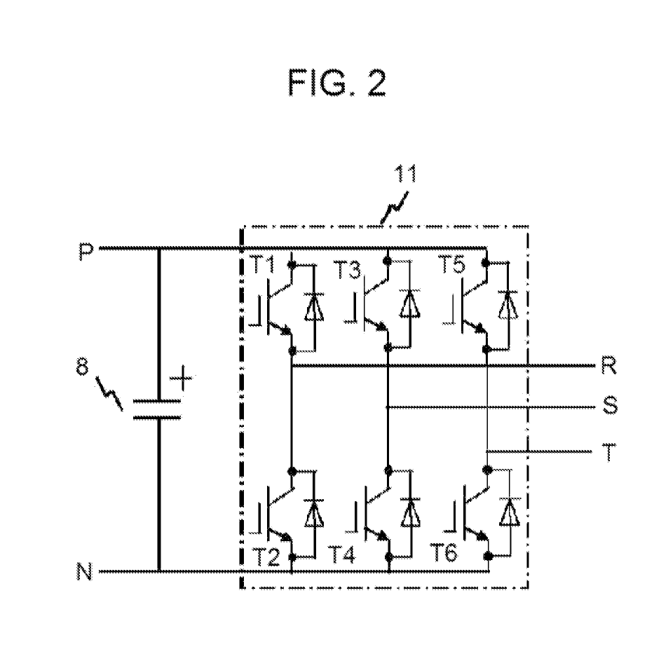

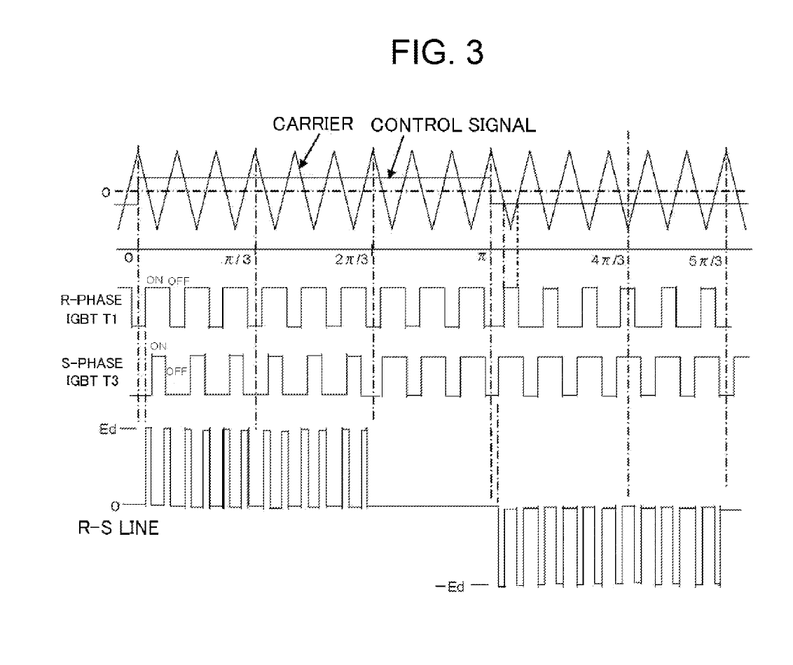

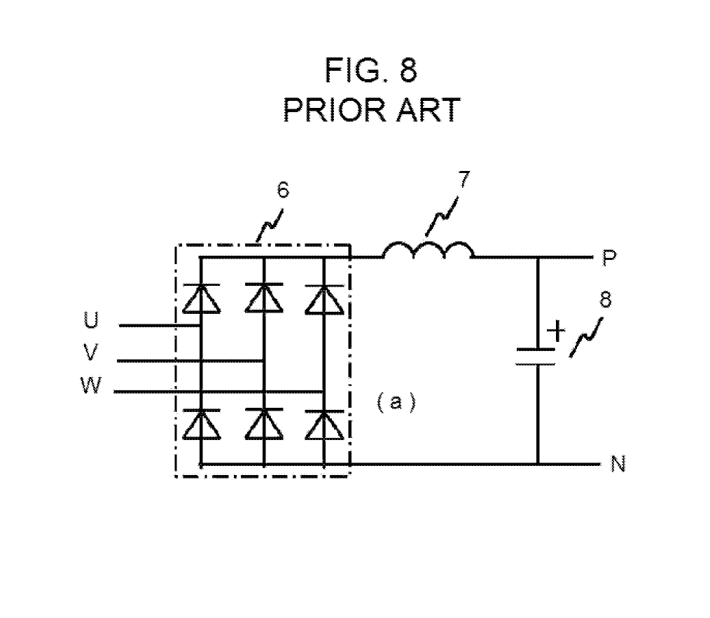

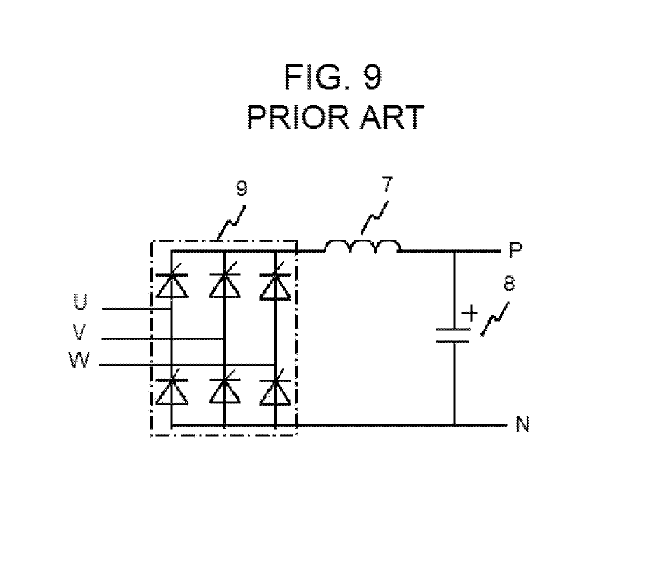

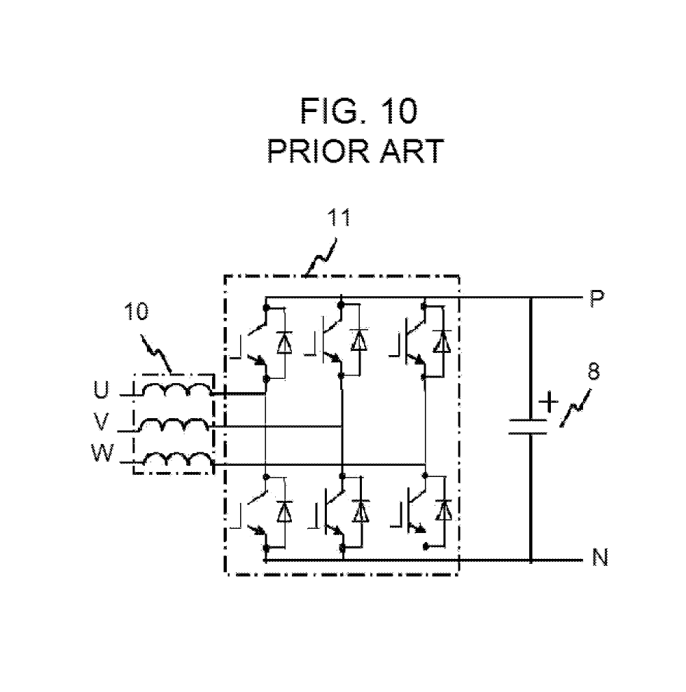

In this kind of configuration, any one of heretofore known circuit configurations shown in FIGS. 8 to 10 is applicable to the AC/DC conversion circuit 4. FIG. 2 shows a detailed circuit of the DC/AC conversion circuit 12, and FIG. 3 shows operating waveform examples thereof. The DC/AC conversion circuit shown in FIG. 2 is a full-bridge inverter circuit, configured of IGBTs T1 to T6 to each of which a diode is connected in anti-parallel, to the direct current inputs of which a capacitor 8 is connected, and to the alternating current outputs (R, S, and T) of which the primary winding of the high frequency transformer is connected. The series connection point of the IGBTs T1 and T2 is the alternating current output R, the series connection point of the IGBTs T3 and T4 is the alternating current output S, and the series connection point of the IGBTs T5 and T6 is the alternating current output T.

FIG. 3 is an operating waveform diagram when a direct current input voltage (the voltage of the capacitor 8) is taken to be Ed. The diagram shows an operation of the R-phase IGBT T1, an operation of the S-phase IGBT T3, and an R-S line voltage.

An on/off signal of each IGBT can be obtained by comparing a control signal for determining a pulse width and a carrier. Herein, it is possible to obtain a positive-negative symmetrical alternating current voltage as an alternating current output by changing a comparison condition for each half cycle of the fundamental wave of the alternating current output. The on/off waveforms of the R-phase IGBTs and the on/off waveforms of the S-phase IGBTs can be obtained by shifting the phases by 120 degrees. The on/off waveforms of the T-phase IGBTs can be obtained by shifting the waveforms of the S-phase IGBTs by 120 degrees, but are omitted here.

A description will be given hereafter of an operation in this kind of configuration. The carrier is a waveform when the frequency thereof is a frequency 18 times the fundamental wave frequency. The direct current voltage Ed is output to the alternating current output R when the IGBT T1 turns on (the IGBT T2 turns off), while a zero voltage is output to the output S when the IGBT T3 turns off (the IGBT T4 turns on), and the R-S line voltage takes an alternating current voltage waveform with 12 pulses included in a 120-degree period of the half cycle, as shown in FIG. 3. An S-T voltage and a T-R voltage also take a waveform having a 120-degree phase difference in the same way. The number of pulses included in the half cycle of each phase voltage is set to a multiple of three in order to equalize the waveform of each line voltage provided with the 120-degree phase difference. In the waveform examples of FIG. 3, the number of pulses of each phase voltage is nine, and the number of pulses in the 120-degree period of the line voltage is 12. These pulse frequencies are determined by the frequency of the carrier. The fundamental wave frequency is limited by the switching characteristics of switching elements, but several kHz or less is practical when the existing IGBTs are used.

Also, the working example has shown a case in which a direct current signal is used as the control signal, but it is also realizable to use a sine wave or a trapezoid wave. When a direct current signal is used, there is an advantage that it is possible to reduce the size of the filter circuit 14 for smoothing, after rectifying the high frequency transformer secondary winding voltage.

### Working Example 2

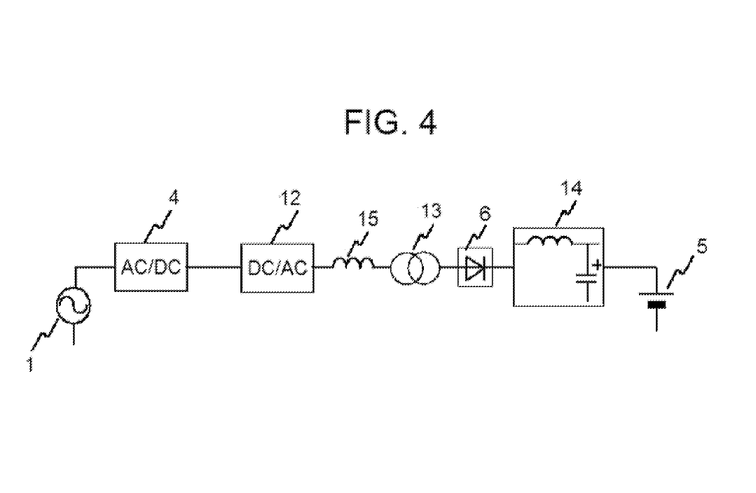

FIG. 4 shows a second working example of the invention. The difference from the first working example is that a reactor 15 is connected between the DC/AC conversion circuit 12 and three-phase high frequency transformer 13.

With the high frequency transformer, as the size of a magnetic body (a core) decreases, and the number of turns a winding is wound around the magnetic body decrease, in response to a higher frequency, leakage inductance decreases. Because of this, the reverse recovery current of the diodes of the rectifier circuit 6 connected to the secondary winding of the high frequency transformer increases, and there arises the problem of an increase in loss.

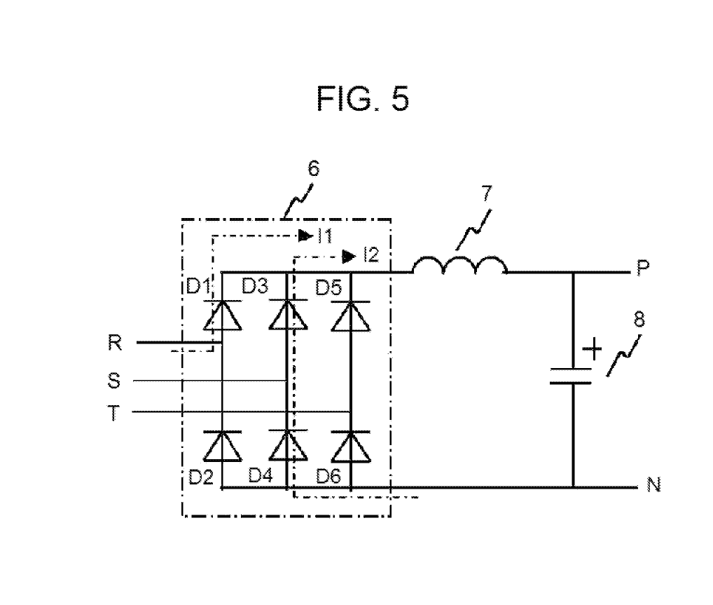

FIG. 5 shows a commutation operation of the rectifier circuit. The rectifier circuit 6 is a diode bridge rectifier circuit configured of diodes D1 to D6. When a pulse voltage is input between, for example, the alternating current inputs R and S, a current I1 flows through the channel of from the diode D1 through the reactor 7 and capacitor 8 to the diode D4, and increases. Next, when the pulse voltage reaches zero, the current of the reactor 7 flows back through the channel of from the diode D4 to the diode D3, changes to a current I2, and decreases. Next, when a pulse voltage is input between R and S, firstly, the diode D3 having been conductive thus far is reverse-recovered, and subsequently, the current path I1 is taken. Herein, a current inclination −di/dt when reverse-recovering the diode D3 is of a value wherein the R-S voltage is divided by the leakage inductance. Consequently, when the leakage inductance of the high frequency transformer is low, it is possible to reduce −di/dt by connecting the reactor 15 in series, and it is possible to suppress a loss and peak voltage when reverse-recovering.

Herein, as it is sufficient that the reactor is inserted in series with the transformer, it is possible to obtain the same advantageous effects by connecting the reactor in series to the primary winding or in series to the secondary winding.

### Working Example 3

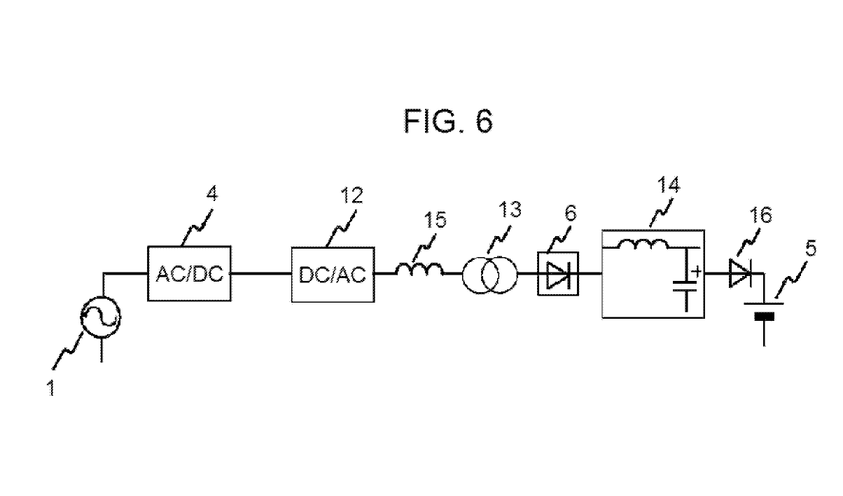

FIG. 6 shows a third working example of the invention. The difference from the second working example is that a diode 16 is connected between the filter 14 and storage battery. When the storage battery 5 is completed to be charged and comes into a floating charge state, a condition is attained in which pulses of a minute width are only intermittently input into the alternating current inputs of the rectifier circuit 6. Because of this, when there is no diode 16, a condition in which a reverse voltage remains applied to the diodes of the rectifier circuit 6 is attained, and the electric charge of the storage battery is discharged due to a reverse leakage current. In order to prevent this, the diode 16 with a low reverse leakage current is connected between the filter 14 and storage battery.

The working example has shown an example wherein a three-phase alternating current input voltage is converted to a three-phase high frequency voltage by using the AC/DC conversion circuit and DC/AC conversion circuit, but this conversion can also be realized by using an AC/AC direct conversion type circuit such as a matrix converter.

The invention, as it is applicable to a conversion equipment which generates a direct current insulated from an alternating current power source, can be applied to a charging equipment, a plating power supply, a sash coloring power supply, or the like.

What follows is a list of reference characters used herein:
1 . . . Alternating current power source
2 . . . Breaker
3 . . . Transformer
4 . . . AC/DC conversion circuit
5 . . . Storage battery
6 . . . Diode rectifier circuit
7, 10, 15 . . . Reactor
8 . . . Capacitor
9 . . . Thyristor rectifier circuit
11 . . . IGBT bridge rectifier circuit
12 . . . DC/AC conversion circuit
13 . . . Three-phase high frequency transformer
14 . . . Filter T1 to T6 . . . IGBT D1 to D6,
16 . . . Diode

1. A power conversion equipment for generating a direct current insulated from a three-phase AC power source to charge a storage battery, comprising:
an AC/DC conversion circuit which rectifies and converts an output of the AC power source to a direct current;
a DC/AC conversion circuit which converts the direct current to a high frequency three-phase AC voltage, the high frequency three-phase AC voltage including 3N pulses (where N is an integer equal to or greater than one) times a fundamental wave frequency in a half cycle of a phase voltage, the fundamental wave frequency being higher than the frequency of the AC power source;
a three-phase high frequency transformer;
first means for connecting a primary winding of the three-phase high frequency transformer to an output of the DC/AC conversion circuit;
a rectifier circuit which rectifies an output of a secondary winding voltage of the three-phase high frequency transformer;
a filter circuit connected to a direct current output of the rectifier circuit; and
second means for connecting an output of the filter circuit to the storage battery.

2. The power conversion equipment according to claim 1, wherein the first means comprises a reactor that is connected in series with the three-phase high frequency transformer.

3. The power conversion equipment according to claim 1, wherein the 3N pulses times the fundamental wave frequency are generated from a direct current amount acting as a control signal and a carrier for modulating a pulse width.

4. The power conversion equipment according to claim 3, wherein the second means comprises a diode that is connected between the output of the filter circuit and the storage battery.

5. The power conversion equipment according to claim 2, wherein the 3N pulses times the fundamental wave frequency are generated from a direct current amount acting as a control signal and a carrier for modulating a pulse width.

6. The power conversion equipment according to claim 5, wherein the second means comprises a diode that is connected between the output of the filter circuit and the storage battery.

7. The power conversion equipment according to claim 3, wherein the secondary means comprises a diode that is connected between the output of the filter circuit and the storage battery.

8. The power conversion equipment according to claim 1, wherein the first means is a conductor that directly connects the primary winding of the 3-phase high-frequency transformer to the output of the DC/AC conversion circuit and the second means is a further conductor that directly connects the output of the filter circuit to the storage battery.
